(19) United States
(12) Patent Application Publication
(10) Pub. No.: US 2021/0372897 A1
(43) Pub. Date: Dec. 2, 2021

(54) HARDNESS TESTING SYSTEMS

(71) Applicant: Illinois Tool Works Inc., Glenview, IL (US)

(72) Inventor: Matthias Pascher, Stuttgart (DE)

(21) Appl. No.: 17/208,587

(22) Filed: Mar. 22, 2021

Related U.S. Application Data
(60) Provisional application No. 63/031,328, filed on May 28, 2020.

(51) Int. Cl. G01N 3/42

(52) U.S. Cl. CPC G01N 3/42; G01N 2203/0617; G01N 2203/0218; G01N 2203/0076

(57) ABSTRACT

A system for measuring a mechanical property of a material or component under test comprises a hardness testing device with a computing device. The hardness testing device is configured to measure at least one measurement value indicative of a hardness of a material or component under test. The computing device includes a display, a processor, and memory. The memory has instructions that, when executed, cause the processor to control the hardness testing device to measure a measurement value indicative of hardness of a material. Executing the instructions further causes the processor to control to save testing data to a database. The computing device accesses the database, calculates a parameter related to hardness, and displays at least one of the portion of the database and the parameter related to hardness.

### RELATED APPLICATIONS

The present application claims the benefit of U.S. Provisional Patent Application Ser. No. 63/031,328, filed May 28, 2020, entitled “HARDNESS TESTING SYSTEMS.” The entirety of U.S. Provisional Patent Application Ser. No. 63/031,328 is expressly incorporated herein by reference.

### BACKGROUND

This disclosure relates generally to systems that measure a mechanical property of a material or component under test, and, more particularly, to hardness testing systems.

Known hardness testing devices, such as penetration hardness testing devices determine the ability of the material to resist permanent deformation. Such systems include an indenter or penetrator, and an actuation mechanism that applies a force so as to apply a preselected load to the penetrator, thereby indenting the specimen being tested. Based on various measurements, including the force applied and a length and/or depth measurement, a hardness value may be determined. In a Vickers-type test, for example, a pyramid-shaped indenter is forced into the specimen. The two diagonal lengths across the indent formed are measured, and the Vickers hardness value may be calculated. For a Knoop-type test, an asymmetrical indenter is used, and an indent with a greater length than width is formed. A hardness value for the Knoop test may be determined from a measure of a diagonal. Numerous other hardness tests are known, and hardness testing devices often can perform a wide array such tests.

As may be expected, a need remains for hardness testing systems and apparatuses that perform testing and other operations in various industries, as well as hardness testing methods. It would be advantageous to provide improved hardness testing systems.

### SUMMARY

In embodiments, a system for measuring a mechanical property of a material or component under test, comprises a hardness testing device configured to measure at least one measurement value indicative of a hardness of a material or component under test. The hardness testing device in embodiments includes a computing device comprising a display device, a processor, and a memory coupled to the processor to store computer readable instructions which, when executed by the processor, cause the processor to control the hardness testing device to measure the at least one measurement value indicative of the hardness of the material, save testing data to a database, the testing data including the at least one measurement value, in response to a command to access the database via the computing device, access at least a portion of the database including the at least one measurement value based on the command, calculate, using the at least one measurement value, a parameter related to hardness associated with the accessed portion of the database, and display, on the display device, the portion of the database and the parameter related to hardness.

The testing data in embodiments includes at least two measurement values and the parameter related to hardness comprises a case hardened depth (CHD) value. In embodiments, the portion of the database comprises values including at least one of a hardness value, at least one conversion of a hardness value, mean hardness value, minimum hardness value, maximum hardness value, standard deviation of hardness values, second standard deviation of hardness value, third standard deviation of hardness value, mean of hardness value without minimum value, mean of hardness value without maximum value, range of hardness values, Cp value, Cpk value, CHD value, surface hardness, base hardness, second base hardness, date, time, force, depth of indent, distance, first diagonal distance, second diagonal distance, symmetry, location information associated with the location on a material or a component under test at which a hardness test was performed.

In embodiments, the testing data further includes location information associated with the location on a material or a component under test at which a hardness test was performed. In embodiments, an input device, wherein the computer readable instructions, when executed, cause the processor to, in response to an initialization event from the input device, display on the display device testing data from multiple hardness tests from at least one of multiple test locations of a material or component under test and multiple materials or components under test.

In embodiments, an input device, wherein the computer readable instructions, when executed, cause the processor to, in response to an initialization event from the input device, display on the display device testing data directly from database. In further embodiments, the system includes an input device, and the computer readable instructions, when executed, cause the processor to, in response to an initialization event from the input device sort the testing data from a plurality of hardness tests by a particular type of testing data, and display the sorted testing data on the display.

In certain embodiments, the system further includes an input device, and the computer readable instructions, when executed, cause the processor to, in response to an initialization event from the input device, generate a graph representative of at least one type of testing data or parameter related to hardness and display the graph on the display.

In embodiments, the testing data includes time and at least one of hardness and distance. In embodiments, the computer readable instructions, when executed, cause the processor to, in response to an initialization event from the input device, generate a graph representative of time and at least one of hardness and distance, and display the graph on the display.

In certain of embodiments where the system includes an input device, the testing data further includes location information associated with the location on a material or a component under test at which a hardness test was performed, and the computer readable instructions, when executed, cause the processor to, in response to an initialization event from the input device, generate a graph representative of at least one testing data value or parameter representative of hardness for a plurality of times, and display the location of the at least one testing data value or parameter representative of hardness for the plurality of times.

In embodiments, the computer readable instructions, when executed, cause the processor to, in response to an initialization event from the input device generate a graph of trending information from multiple hardness tests from at least one of multiple test locations of a material or component under test and multiple materials or components under test, the trending information including at least one type of testing data, and display the graph on the display. In some embodiments, the trending information is selectable via a user input device.

In other embodiments, a device for accessing database data for mechanical properties of materials or components under test comprises a display device, an input device, a processor, and a memory coupled to the processor to store computer readable instructions which, when executed by the processor, cause the processor to, in response to an initialization event from the input device save testing data to a database, the testing data including the at least one measurement value, in response to a command to access the database, access at least a portion of the database including the at least one measurement value based on the command, calculate, using the at least one measurement value, a parameter related to hardness associated with the accessed portion of the database, and display, on the display device, the portion of the database and the parameter related to hardness.

In embodiments, the data includes at least two measurement values and the parameter related to hardness comprises a case hardened depth value. In certain embodiments, the portion of the database comprises values including at least one a hardness value, at least one conversion of a hardness value, mean hardness value, minimum hardness value, maximum hardness value, standard deviation of hardness values, second standard deviation of hardness value, third standard deviation of hardness value, mean of hardness value without minimum value, mean of hardness value without maximum value, range of hardness values, Cp value, Cpk value, CHD value, surface hardness, base hardness, second base hardness, date, time, force, depth of indent, distance, first diagonal distance, second diagonal distance, symmetry, location information associated with the location on a material or a component under test at which a hardness test was performed.

The testing data in embodiments includes time and at least one of at least one testing data value and a parameter representative of hardness. In other embodiments, the computer readable instructions, when executed, cause the processor to, in response to an initialization event from the input device, display on the display device testing data from multiple hardness tests from at least one of multiple test locations of a material or component under test and multiple materials or components under test. In certain embodiments, the computer readable instructions, when executed, cause the processor to, in response to an initialization event from the input device, display on the display device testing data directly from database.

In other embodiments of the device, the computer readable instructions, when executed, cause the processor to, in response to an initialization event from the input device sort the testing data from a plurality of hardness tests by a particular type of testing data, and display the sorted testing data on the display.

In certain embodiments, the testing data further includes distance and time. In some embodiments, the computer readable instructions, when executed, cause the processor to, in response to an initialization event from the input device, generate a graph representative of at least one type of testing data or parameter related to hardness and display the graph on the display. In some particular embodiments, the testing data includes time and at least one of hardness and distance. In embodiments, the computer readable instructions, when executed, cause the processor to, in response to an initialization event from the input device, generate a graph representative of time and at least one of hardness and distance, and display the graph on the display.

In some embodiments, the testing data further includes location information associated with the location of a material or a component under test at which a hardness test was performed, and the computer readable instructions, when executed, cause the processor to, in response to an initialization event from the input device, generate a graph representative of at least one testing data value or parameter representative of hardness for a plurality of times, and display the location of the at least one testing data value or parameter representative of hardness for the plurality of times.

In some embodiments, the computer readable instructions, when executed, cause the processor to, in response to an initialization event from the input device: generate a graph of trending information from multiple hardness tests from at least one of multiple test locations of a material or component under test and multiple materials or components under test, the trending information including at least one type of testing data, and display the graph on the display. In yet other embodiments, the trending information is selectable via the user input device.

### BRIEF DESCRIPTION OF THE DRAWINGS

FIG. 1 illustrates an example hardness testing system.

FIG. 2 is a block diagram of components of the hardness testing system of FIG. 1.

FIG. 3 illustrates an example user interface of a hardness testing system.

FIG. 4 illustrates an example user interface of a hardness testing system.

FIG. 5 illustrates a flow chart of a method of using a hardness testing system.

FIG. 6 illustrates a flow chart of a method of using a hardness testing system.

The figures are not necessarily to scale. Where appropriate, similar or identical reference numbers are used to identify similar or identical components.

### DETAILED DESCRIPTION

The present disclosure is directed generally to hardness testing systems, apparatuses, and methods. Preferred embodiments will be described with reference to the figures of the accompanying drawings. In the following description, well-known functions or constructions are not described in detail, since such descriptions would obscure the disclosure in unnecessary detail.

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the term “embodiments” does not require that all disclosed embodiments include the discussed feature, advantage, or mode of operation.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first set of one or more lines of code and may comprise a second “circuit” when executing a second set of one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by an operator-configurable setting, factory trim, etc.).

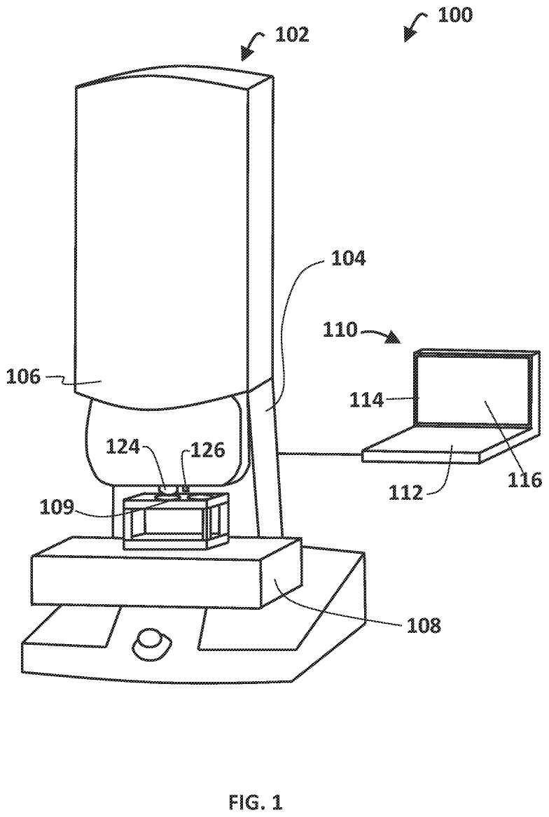

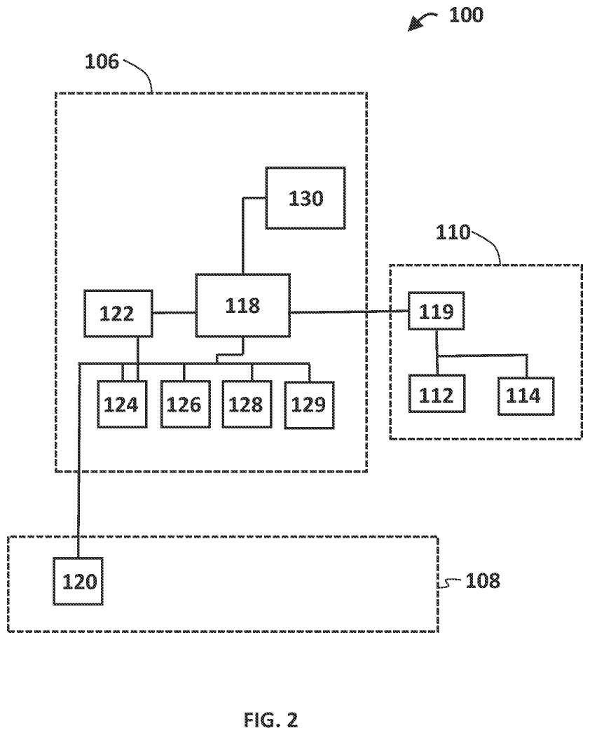

FIGS. 1-4 depict an embodiment of a hardness testing system. With reference to FIG. 1, a hardness testing system 100 includes a hardness tester 102 with a support frame 104, a test module 106, and a specimen stage 108. In this embodiment, the support frame 104 supports the module 106. The specimen stage 108 is also mounted to the support frame 104. A workpiece or specimen under test may be placed on the specimen stage 108 to undergo testing. The specimen stage 108 in the embodiment depicted is a movable stage that is motorized in the XY-directions, and may be controlled to enable auto sequencing of multiple samples, such as samples 109 shown. With reference to FIG. 2, the specimen stage 108 includes an actuator 120 configured to move the stage in the X-Y directions.

Returning to FIG. 1, the test module 106 includes an objective unit 124 and indenters 126. Turning again to FIG. 2, the test module 106 further includes a camera system 128. The camera system 128 is a digital camera that provides for navigation over the entire workpiece or specimen under test, and provides for accurate indent positioning. Any desired camera system may be utilized. The objective unit 124 has a number of objectives to provide for multiple fields of view by changing (e.g., rotating) the objective unit 124 to position the desired objective with respect to the specimen stage 108. The objective unit 124 may be manually moved (e.g., rotated) by a user, or, may be moved by an actuator 122 that is configured to rotate the objective unit 124 to an operating position. The actuator 122 is further configured to move the module 106 with respect to the specimen stage 108 (e.g., the Z-direction). Thus, the actuator 122 may be controlled to move the indenters 126 into contact with a workpiece or specimen under test and to move the objectives and camera system towards and away from the workpiece or specimen during operation.

While in the embodiment depicted the stage 108 is configured to be moved in the X-Y directions by actuator 120 and the test module 106 is configured to be moved in the Z direction by actuator 122, in other embodiments, either or both of the stage and the test module may be configured to be moved by actuators in the X, Y, and/or Z directions, as desired. For example, in embodiments, the stage is configured to be moved in the Z direction. In embodiments, the test module is configured to be moved in the X-Y directions. In certain embodiments, the stage is a static stand, and actuators move the test module in the X, Y, and Z directions. Any desirable stage or stand, and any desired actuator(s), may be implemented to achieve proper positioning of the stage/stand and the test module with respect to one another. The system may also include additional components desired for the hardness testing system, such as the force sensor unit 129 depicted in FIG. 2. In embodiments, force sensor unit 129 includes a load cell (e.g., closed loop, open loop) configured to sense a load applied by the indenters 126 to the specimen under test. In other embodiments, a deadweight tester is implemented with calibrated weights that are controlled to apply known pressures to the specimen via the indenter. In yet other embodiments, general and/or flex springs are controlled to apply the load to the specimen via the indenter.

The hardness tester 100 also includes control circuitry or controller 118. The control circuitry or controller 118 comprises circuitry (e.g., a microcontroller and memory such as a non-transitory machine-readable storage device) operable to receive and process data or control signals from a control unit 110, actuators 120, 122, the camera system 128, and force sensor unit 129 and, in response, control the components of the hardness testing system. In embodiments with a deadweight tester or spring systems that apply the load to the specimen, the controller 118 is also operable to process data or control signals from such systems. The controller 118 may include processor(s) and/or other logic circuitry that controls system operations. Example processor(s) may include one or more microprocessors, such as one or more “general-purpose” microprocessors, one or more special-purpose microprocessors and/or ASICS, one or more microcontrollers, and/or any other type of processing and/or logic device. For example, the controller 118 may include one or more digital signal processors (DSPs).

The hardness testing system 100 further includes a control unit 110. In the embodiment shown, the control unit 110 enables users to input commands, as well as view and edit testing parameters, variables, and other data and information related to hardness tests and the testing system. In the embodiment shown, the control unit 110 includes an input device 112 and a display 114 with a graphical user interface 116. The display 114 displays data and information related to hardness testing, including testing data, parameters related to hardness, statistics related to hardness testing, and the like, in a manner desired by the user. The graphical user interface 116 has a number of different screens, menus, display formats, windows, areas, and settings, which are selectable by a user.

With reference to FIG. 2, the control unit 110 includes controller circuitry or controller 119. The control circuitry or controller 119 comprises circuitry (e.g., a microcontroller and memory such as a non-transitory machine-readable storage device) operable to communicate with the hardness tester 102. For example, the controller 119 may be linked, directly or indirectly, with the hardness tester 102 via a communication cable (e.g., USB, serial, etc.) or a wireless connection. Controller 119 may communicate with the controller 118 and/or any of the hardware components of the hardness tester, such as actuators 120, 122, camera system 128, force sensor 129 and any other components of a hardness tester. Control unit 110 may be used to control the components of the testing device 102, provide user input, and receive data and control signals from the various components of the hardness tester 102, such as actuators 120, 122, camera system 128, force sensor 129 and any other components of a hardness tester.

In embodiments, control unit 110 is a mobile computing device with a touchpad and keyboard-type input device and monitor-type display. Any desired control unit, input device, or display device may be utilized. For example, a controller, control panel, handheld portable device, computer, mobile telephone, smartphone, tablet, personal computer (PC), kiosk, desktop computer, laptop computer, notebook computers, smartphone, tablet personal computer (PC), kiosk, desktop computer, touchscreen device, keyboard, touchpad, buttons, switches, or any other desired controller, display, or input device may be implemented to provide user input, process control signals and data, or display information related to the system. Multiple control units, multiple displays, or multiple input devices may also be utilized to control the system, accept user input, display or communicate information to a user, process signals and data, and so on. The control unit(s) may communicate with the hardness tester or certain of or all of its components, wired or wirelessly, at the location of a hardness tester, or at a location remote from a hardness tester.

One or both controllers 118, 119 are further configured to access, process, edit, and save data and information related to hardness testing. The data and information may be stored locally, remotely, or a combination. The controllers 118, 119 may access, process, edit, and save data, for example, from a single test, plural tests over time, a single sample, multiple samples, a single location on a sample, multiple location on a sample, multiple locations on multiple samples, and the like.

In embodiments, the data and information includes testing data such as measurement values of the hardness testing system. Measurement values in hardness testing systems may include various values measured by a hardness testing system, such date, time, force, depth, distance (e.g., first diagonal distance, second diagonal distance), symmetry (e.g., symmetry of first and second diagonals), and so forth. In embodiments, the values are measured with respect to one or more indents created on a sample during a test, and may depend on the particular type of hardness test selected (e.g., Vickers, Knoop, Rockwell, etc.). For example, in a Vickers-type test, distance may include a first distance (D1) and a second distance (D2) taken across diagonals of the indent. The depth in embodiments is the depth of an indent. Controller 118 and/or 119 saves the dates and times that tests are performed, test duration, etc. Controller 118 and/or 119, in embodiments, determines force values from control signals received from force sensor unit 129 (or the signals from other systems, such as deadweight tester systems and spring systems) generated during a hardness test. In embodiments, controller 118 and/or 119 processes image data of indents captured during hardness testing from camera system 128. Controller 118 and/or 119 is configured to determine distance and depth values, for example, of indents formed during a hardness test, based on image data and/or user input. Any desired way of obtaining and/or determining measurement values may be implemented.

The data and information also includes parameters related to hardness. Controller 118 and/or 119 is configured to determine various parameters related to hardness, such as hardness values, based at least on testing data, such as one or more measurement values. In embodiments, the parameters related to hardness include hardness values (e.g., Vickers value, Knoop hardness, Rockwell value, etc.), conversions (conversions from one hardness value type to another by, for example, a lookup table), CHD values, surface hardness, base hardness, and so forth. The data and information also includes other testing data and statistics, for example, hardness values, conversions, mean hardness values, minimum hardness values, maximum hardness values, standard deviation, second standard deviation, third standard deviation, average mean of hardness values, mean of hardness minus minimum, mean of hardness minus maximum, range of hardness values, Cp value, Cpk value, and so forth. Various other testing data and statistics may also be stored, for example, time of testing, date of testing, duration of tests, averages, total time, information associated with the location on a material or a component under test at which testing was performed, information associated with the location of the test machine, test identification information, including name of test and type of test, material properties, and so forth. Controller 118 and/or 119 may also process any such data to determine various values and statistics.

The data and information, such as the test data, measurement values, parameters, and statistics, and so forth, are saved to a memory, locally or remotely. In embodiments, the data is saved to a database that is accessible by controller 118 and/or 119 and may be further accessed by other devices (e.g., other hardness testing systems, remote computing devices, etc.). The parameters related to hardness may be calculated by controller 118 and/or 119 and stored to memory. Alternatively, the parameters related to hardness may be calculated by controller 118 and/or 119 upon a request by a user to display the parameters, based on the various saved data and information, such as the testing data.

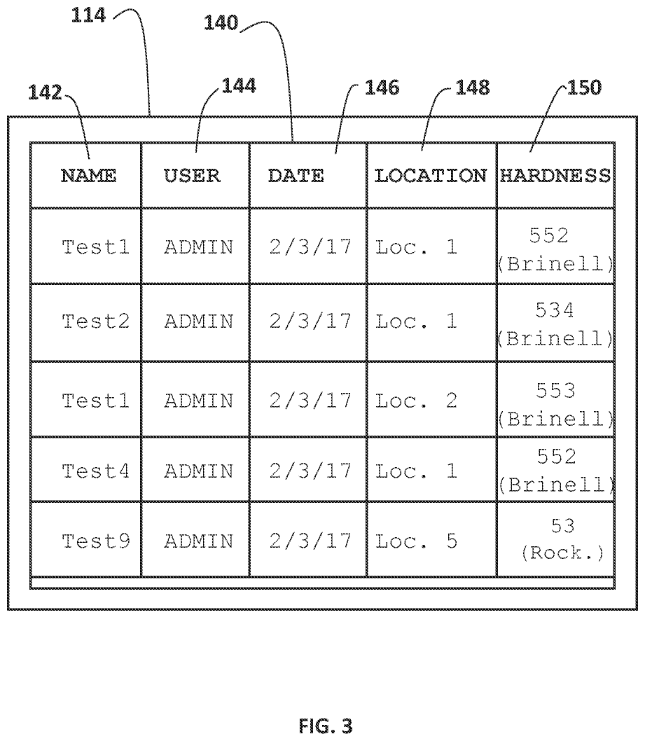

The controller 118 and/or 119 is further configured to access saved data and information, process the accessed data and information, and display saved and processed data and information on the display 114 of the control unit 110. For example, the controller 118 and/or 119 is configured to access, process, and display data and information related to hardness testing from a database, for example, on a display such as display 114. With reference to FIG. 3, in response to commands from a user input, the controller 118 and/or 119 accessed a database to retrieve data and information, processed the data, and controlled display 114 to display various data types 142, 144, 146, 148, 150. In this example, the data types 142, 144, 146, 148, 150 are represented in the form of a chart or spreadsheet 140. The values associated with each data type appears in the rows of each column. In the depicted examples, data-types 142, 144, 146, 148, 150 include the program or test name, the last user (e.g., to edit the data), the creation date, the location, and a hardness value. The data-types 142, 144, 146, and 148 were retrieved from a database created by controller 118 over the course of time as the users have performed plural hardness tests. The values for data type 150 (hardness values), were calculated and displayed by controller 118 and/or 119 based on testing data from various hardness tests stored in the database. While the hardness values in this embodiment were calculated from testing values in the database in response to a user request to display the hardness values, in embodiments, the hardness values are calculated and stored in the database with the other data and information at a prior time, for example, when the tests are performed. In such embodiments, controller 118 and/or 119 accesses and displays the hardness values directly from the database.

While chart 140 depicts data-types 142, 144, 146, 148, 150, any number of data types may be selected as desired. In addition, while the particular datatypes depicted are test name, the last user, the creation date, the location, and a hardness value, any of the data and information, such as testing data, measurement values, parameters, other statistics, and so forth, may be selected. Further, a user may select the number of fields to display. Data may also be displayed for a single test, or any number of tests, performed on a single specimen or multiple specimens.

The data may be further processed in ways desired by the user. For example, the data may be sorted in ascending order, descending order, by data type, by test type, by location, by test identification or name, by location, and so on. By way of further example, from user input at the control unit 110, columns of data may be sorted and searches for particular data can be performed and displayed. In embodiments where data is stored in a database, controller 118 and/or 119 may be configured to access the database and display the values directly from the database. In certain of such embodiments, a user may edit the data using the input device, which causes, for example, controller 118 and/or 119 to cause the data in the database to be edited accordingly. In this regard, a user may directly edit data and information in the database. Rights to view and/or edit such data may also be reserved to certain users, such as administrators, and thus, in embodiments, such may only be edited by an administrator or in an administrator mode.

While a chart or spreadsheet is depicted in FIG. 3, many other forms of display may be used as desired. For example, the data may be shown in various types of charts, graphs, lists, groups, text, spreadsheets, graphical representations, and so forth. In embodiments where data and information is read from a database, a user need not, for example, export data to a readable format, (e.g., CSV, xls, etc.) to access and/or display the data in a desired manner. Similarly, by accessing the database directly, database data may be directly edited.

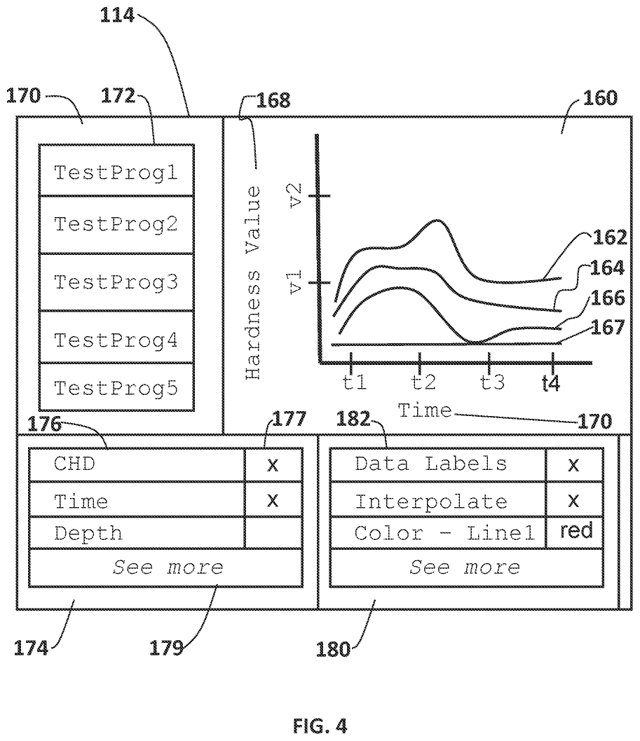

Turning to FIG. 4, in another example, in response to input from a user, display 114 shows a graphical area 160 with various trendlines 162, 164, 166 associated with hardness tests performed by system 100. In the embodiment depicted, the Y-axis values 168 are hardness values and the X-axis values 170 are time (e.g., date, time, sequence) that the tests were performed. In response to a request by the user to display the trendlines, controller 118 and/or 119 accesses the memory to retrieve values from a database for hardness tests performed for various selected test jobs. The hardness values, in embodiments, may also be calculated based on data and information, such as testing information, retrieved from the database. In this embodiment, processing algorithms (e.g., interpolation, regression, extrapolation) are performed to depict visually a curved trendline given the data points retrieved from the database, however, any visually line or graph type desired by the user may be utilized.

In embodiments, the trendlines 162, 164, 166 represent various hardness tests performed, for example, on multiple specimens, at multiple times, at multiple locations on one or more specimens, and the like. Other information and trendlines may be displayed with the trendlines 162, 164, 166. In the embodiment depicted, for example, in response to user commands, a base hardness 167 is displayed with the trendlines 162, 164, 166. Any other desired field may be displayed. In yet another example, a secondary axis (e.g., a second y-axis) associated with another field may be added in response to user input.

While the graphical area 160 depicts trendlines of hardness over time, any data and information related to the hardness testing system may be made the basis of trendlines. For example, the data assigned to the X and Y axes may be any test data, measurement values, parameters, statistics, system information or other data and information from the system. Within the user interface 114, a user may select any of the data and information saved to, for example, a database, by the system, to be made the basis of a trendline. In the particular embodiment depicted in FIG. 4, selection area 170 includes various user-selectable test programs 172. The test programs, in embodiments, are saved test programs, such as one or more tests associated with a particular products, materials, test locations, or any desired collection of test data and information. When selected, fields associated with the test programs populate in selection area 174. A user may select in selection area 174 the various data and information 176 to be represented as trendlines. The checkboxes 177 indicate which of the data and information is selected. In FIG. 4, the viewable data and information 176 that can be selected by a user includes case hardened depth (CHD), time, and depth, however, any of the available data and information is viewable and may be made the basis of trendlines In the embodiment shown, for example, further selectable data is viewable by pressing button 179. Checkboxes 177 indicate whether a particular data type has been selected. Upon selecting the data, control unit 110 calculates the trendlines and displays them in graphical area 160 with the corresponding values.

Selection area 180 includes additional options for displaying information in the graphical area 160. For example, selection area 180 may include checkboxes, drop boxes, or other user inputs to enable a user to select various other options. In an embodiment, selection area 180 includes options 182 that cause data labels to be displayed, and to interpolate the trendlines. The ranges for the X and Y axes may also be selected. Other fields may be selected in selection area 180, such as format data 182. Format data may include color, line weight, line type or other formatting options for one or more of the trendlines (e.g., CHD is a red trendline; Base hardness is green, and so forth). The trendlines in graph area 160 are updated to reflect the selected formatting. Any desired viewing option may be included in the selection areas. While a particular user interface is described with respect to FIG. 4, it should be understood that any desired form of selecting data and information to be graphically displayed, e.g., in trendlines, may be implemented, including various screens, menus, inputs, and the like.

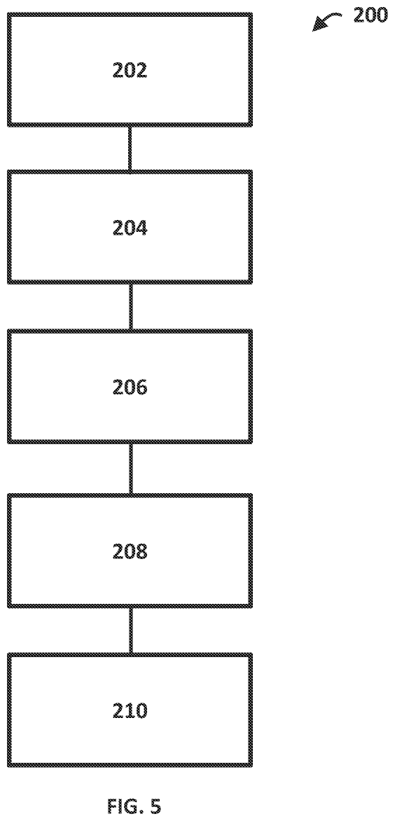

A method 200 of operating a hardness testing system is represented in FIG. 5, which includes executing machine-readable instructions to cause a controller to perform steps 202-210. Step 202 includes controlling a hardness testing device to measure at least one measurement value indicative of the hardness of a material. Step 204 includes saving testing data to a database. The testing data includes the at least one measurement value. Steps 206-210 are performed in response to a command to access the database via a computing device. Step 206 includes accessing at least a portion of the database including the at least one measurement value based on the command. Step 208 includes calculating, using the at least one measurement value, a parameter related to hardness associated with the accessed portion of the database. Step 210 includes displaying, on a display device, a portion of the database and the parameter related to hardness.

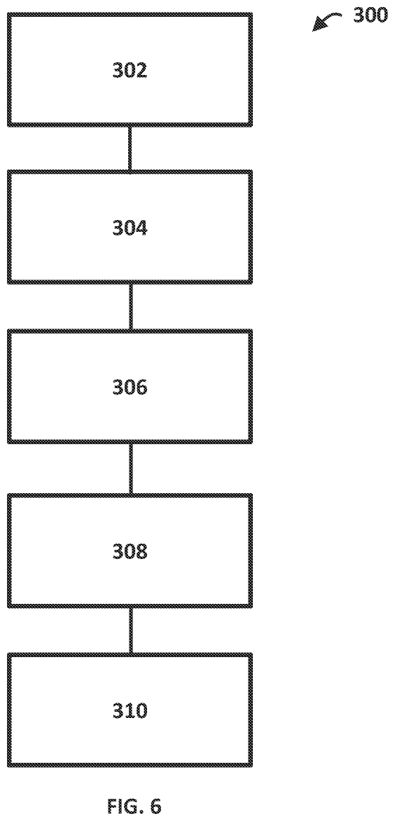

A method 300 of operating a hardness testing system is represented in FIG. 6, which includes executing machine-readable instructions to cause a controller to perform steps 302-310. Step 302 includes controlling a hardness testing device to measure at least one measurement value indicative of the hardness of a material. Step 304 includes saving testing data to a database. The testing data includes the at least one measurement value. Steps 306-310 are performed in response to a command to access the database via a computing device. Step 306 includes accessing at least a portion of the database including the at least one measurement value based on the command. Step 308 includes generating a graph representative of at one type of testing data or a parameter related to hardness. Step 310 includes displaying, on a display device, the graph.

Methods and systems described may be realized in hardware, software, or a combination of hardware and software. The methods and/or systems may be realized in a centralized fashion in at least one computing system or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

The foregoing description and accompanying figures illustrate the principles, preferred embodiments, and modes of operation. However, the disclosure should not be construed as being limited to the particular embodiments discussed above. Additional variations of the embodiments discussed above will be appreciated by those skilled in the art.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, blocks and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents. While the controllers and methods are described as being employed in connection with a hardness testing systems, the teachings may be similarly applied to other devices where it is desirous to determine control hardness testing operations.

All documents cited herein, including journal articles or abstracts, published or corresponding U.S. or foreign patent applications, issued or foreign patents, or any other documents are each entirely incorporated by reference herein, including all data, tables, figures, and text presented in the cited documents.

1. A system for measuring a mechanical property of a material or component under test, comprising:
a hardness testing device configured to measure at least one measurement value indicative of a hardness of a material or component under test,
a computing device comprising:
a display device;
a processor; and
a memory coupled to the processor to store computer readable instructions which, when executed by the processor, cause the processor to:
control the hardness testing device to measure the at least one measurement value indicative of the hardness of the material; and
save testing data to a database, the testing data including the at least one measurement value;
in response to a command to access the database via the computing device:
access at least a portion of the database including the at least one measurement value based on the command;
calculate, using the at least one measurement value, a parameter related to hardness associated with the accessed portion of the database; and
display, on the display device, at least one of the portion of the database and the parameter related to hardness.

2. The system of claim 1, wherein the testing data includes at least two measurement values and the parameter related to hardness comprises a case hardened depth value.

3. The system of claim 1, wherein the portion of the database comprises values including at least one of a hardness value, at least one conversion of a hardness value, mean hardness value, minimum hardness value, maximum hardness value, standard deviation of hardness values, second standard deviation of hardness value, third standard deviation of hardness value, mean of hardness value without minimum value, mean of hardness value without maximum value, range of hardness values, Cp value, Cpk value, CHD value, surface hardness, base hardness, second base hardness, date, time, force, depth of indent, distance, first diagonal distance, second diagonal distance, symmetry, location information associated with the location on a material or a component under test at which a hardness test was performed.

4. The system of claim 1, wherein the testing data further includes location information associated with the location on a material or a component under test at which a hardness test was performed.

5. The system of claim 1, further comprising an input device, wherein the computer readable instructions, when executed, cause the processor to, in response to an initialization event from the input device, display on the display device testing data from multiple hardness tests from at least one of multiple test locations of a material or component under test and multiple materials or components under test.

6. The system of claim 1, further comprising an input device, wherein the computer readable instructions, when executed, cause the processor to, in response to an initialization event from the input device, display on the display device testing data directly from database.

7. The system of claim 1, further comprising an input device, wherein the computer readable instructions, when executed, cause the processor to, in response to an initialization event from the input device:
sort the testing data from a plurality of hardness tests by a particular type of testing data; and
display the sorted testing data on the display.

8. The system of claim 1, wherein the testing data includes time and at least one of at least one testing data value and the parameter related to hardness.

9. The system of claim 1, further comprising an input device, wherein the computer readable instructions, when executed, cause the processor to, in response to an initialization event from the input device, generate a graph representative of at least one type of testing data and display the graph on the display.

10. The system of claim 8, further comprising an input device, wherein:
the computer readable instructions, when executed, cause the processor to, in response to an initialization event from the input device, generate a graph representative of time and at least one of hardness and distance, and display the graph on the display.

11. The system of claim 9, further comprising an input device, wherein:
the testing data further includes location information associated with the location on a material or a component under test at which a hardness test was performed; and
the computer readable instructions, when executed, cause the processor to, in response to an initialization event from the input device, generate a graph representative of at least one testing data value or parameter representative of hardness for a plurality of times, and display the location of the at least one testing data value or parameter representative of hardness for the plurality of times.

12. The system of claim 1, wherein the computer readable instructions, when executed, cause the processor to, in response to an initialization event from the input device:
generate a graph of trending information from multiple hardness tests from at least one of multiple test locations of a material or component under test and multiple materials or components under test, the trending information including at one type of testing data; and
display the graph on the display.

13. The system of claim 12, further comprising an input device, wherein the trending information is selectable via the user input device.

14. A device for accessing database data for mechanical properties of materials or components under test, the device comprising:
a display device;
an input device;
a processor; and
a memory coupled to the processor to store computer readable instructions which, when executed by the processor, cause the processor to, in response to an initialization event from the input device:
save testing data to a database, the testing data including at least one measurement value;
in response to a command from the processor:
access at least a portion of the database including the at least one measurement value based on the command;
calculate, using the at least one measurement value, a parameter related to hardness associated with the accessed portion of the database; and
display, on the display device, at least one of the portion of the database and the parameter related to hardness.

15. The device of claim 14, wherein the testing data includes at least two measurement values and the parameter related to hardness comprises a case hardened depth value

16. The device of claim 14, wherein the portion of the database comprises values including at least one of a hardness value, at least one conversion of a hardness value, mean hardness value, minimum hardness value, maximum hardness value, standard deviation of hardness values, second standard deviation of hardness value, third standard deviation of hardness value, mean of hardness value without minimum value, mean of hardness value without maximum value, range of hardness values, Cp value, Cpk value, CHD value, surface hardness, base hardness, second base hardness, date, time, force, depth of indent, distance, first diagonal distance, second diagonal distance, symmetry, location information associated with the location on a material or a component under test at which a hardness test was performed.

17. The system of claim 14, wherein the testing data includes time and at least one of at least one testing data value and a parameter representative of hardness

18. The device of claim 14, wherein the computer readable instructions, when executed, cause the processor to, in response to an initialization event from the input device, display on the display device testing data from multiple hardness tests from at least one of multiple test locations of a material or component under test and multiple materials or components under test.

19. The device of claim 14, wherein the computer readable instructions, when executed, cause the processor to, in response to an initialization event from the input device, display on the display device testing data directly from database.

20. The device of claim 14, wherein the computer readable instructions, when executed, cause the processor to, in response to an initialization event from the input device:
sort the testing data from a plurality of hardness tests by a particular type of testing data; and
display the sorted testing data on the display.

21-26. (canceled)
